(19) United States
(12) Patent Application Publication
(10) Pub. No.: US 2003/0218826 A1
(43) Pub. Date: Nov. 27, 2003

(54) Composite base assembly for a disc spindle motor and actuator assembly

(76) Inventors: Yiren Hong, Singapore (SG); Pohlye Lim, Singapore (SG); Mo Xu, Singapore (SG)

Correspondence Address: Deirdre Megley Kvale, Westman, Champlin & Kelly, Suite 1600, International Centre, 900 Second Avenue South, Minneapolis, MN, 55402-3319, US

(21) Appl. No.: 10/295,498

(22) Filed: Nov. 15, 2002

Related U.S. Application Data
(60) Provisional application No. 60/383,039, filed on May 23, 2002.

(51) Int. Cl. G11B 17/00

(52) U.S. Cl. 360/97.01

(57) ABSTRACT

A composite base for a disc spindle motor and an actuator spindle assembly including disc spindle portion, an actuator spindle portion and a flange portion. The composite base includes a disc hub portion and an actuator hub portion. The composite base is assembled to a base chassis of a disc drive to form the disc spindle motor assembly and the actuator spindle assembly of the data storage device.

### CROSS-REFERENCE TO RELATED APPLICATION

This application claims priority from U.S. Provisional Application 60/383,039 filed on May 23, 2002 and entitled “INTEGRATED SPINDLE MOTOR AND PIVOT CARTRIDGE FOR HARD DISK DRIVE.”

### FIELD OF THE INVENTION

The present invention relates generally to data storage devices, and more particularly but not by limitation to a composite base assembly for a disc spindle motor and actuator spindle assembly.

### BACKGROUND OF THE INVENTION

Data storage devices store digital information on a disc or storage media and heads read data from or write data to the disc or storage media. Disc or discs of the data storage devices are coupled to a spindle motor. The spindle motor is energized to rotate the discs for operation. Heads are coupled to an actuator assembly. The actuator assembly includes an actuator spindle assembly. A motor, such as a voice coil motor, is coupled to the actuator spindle assembly and is energized to position the heads for read-write operations.

The disc spindle motor includes a stationary hub portion and a rotating spindle portion which rotates relative to the stationary hub portion. Disc or discs are supported on the rotating spindle portion for read/write operation. The actuator spindle assembly includes a stationary shaft or hub portion and a rotating spindle portion. The disc spindle motor and the actuator spindle assembly are assembled to the base chassis for use. The base chassis is transferred for assembly of the actuator spindle assembly or disc spindle motor at an assembly site or location. In particular, the base chassis is transferred to assemble the actuator spindle assembly at an actuator assembly site. Transfer of the base chassis for assembly to a remote assembly site is expensive due to the size and weight of the base chassis. Embodiments of the present invention provide solutions to these and other problems, and offer other advantages over the prior art.

### SUMMARY OF THE INVENTION

The present invention relates to a composite base for a disc spindle motor and an actuator spindle assembly including a disc spindle motor portion, an actuator spindle portion and a flange portion. The composite base includes a disc hub portion and an actuator hub portion. The composite base is assembled to a base chassis of a disc drive or device to form the disc spindle motor assembly and the actuator spindle assembly of the data storage device. Other features and benefits that characterize embodiments of the present invention will be apparent upon reading the following detailed description and review of the associated drawings.

### BRIEF DESCRIPTION OF THE DRAWINGS

FIG. 1 is a perspective illustration of a data storage device or disc drive.

FIG. 2 is an illustration of a prior art embodiment of a disc spindle motor assembly and mounting flange.

FIG. 3 is a prior art illustration of the disc spindle motor assembly of FIG. 2 secured to a base chassis having an actuator sleeve formed on the base chassis for assembly of a rotating actuator spindle.

FIG. 4 is a perspective illustration of an embodiment of a composite base of the present invention for a disc spindle motor assembly and an actuator spindle assembly to movably support heads.

FIG. 5 is a cross-sectional view of the embodiment of the composite base of FIG. 4 including a rotating disc spindle portion.

FIG. 6 is an embodiment of an assembly flow chart of the present invention.

### DETAILED DESCRIPTION OF ILLUSTRATIVE EMBODIMENTS

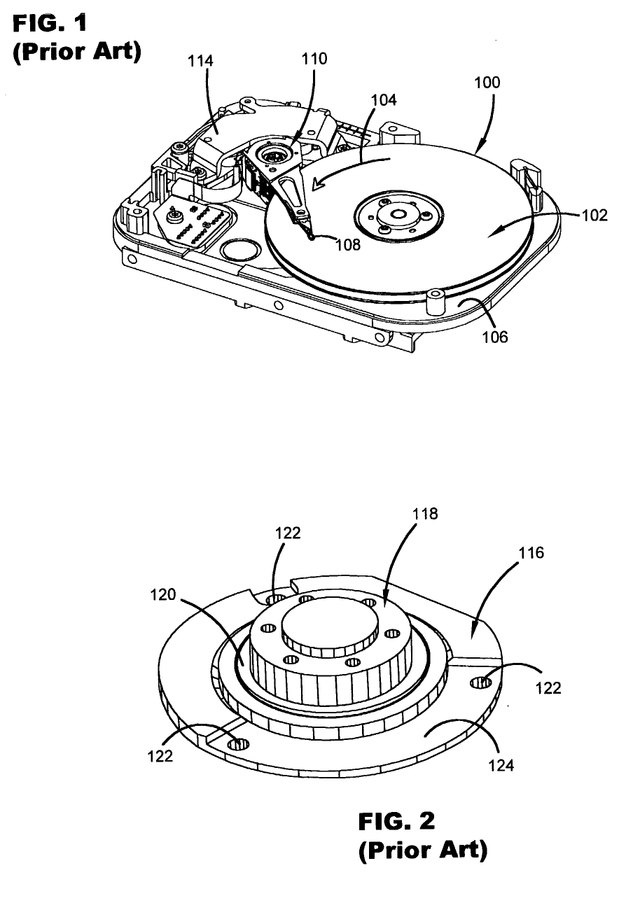

FIG. 1 is a perspective illustration of an embodiment of a data storage device 100 or disc drive in which embodiments of the present invention are useful. Device 100 includes at least one data storage disc 102 rotationally (as illustrated by arrow 104) coupled to a base chassis 106 by a spindle motor (not shown in FIG. 1). Heads 108 are coupled to an actuator assembly 110 as shown. The actuator assembly 110 is energized by a motor or voice coil motor 114 to position the heads 108 relative to selected data tracks of the disc 102 for read-write operations through interface with a host system (not shown). In the illustrated embodiment the device 100 includes a plurality of discs 102 and a plurality of heads 108 coupled to the actuator assembly 110, although application of the present invention is not so limited.

FIG. 2 illustrates a prior art embodiment of disc spindle motor assembly 116 including a rotating disc spindle 118. Discs 102 are supported on a rim 120 of the rotating disc spindle 118. Multiple discs (not shown) can be stacked on the rim portion and separated by spacers. The disc spindle motor assembly 116 is assembled to the base chassis 106 of the data storage device via fasteners (not shown) extending through fastener openings 122 on a disc spindle motor base flange 124.

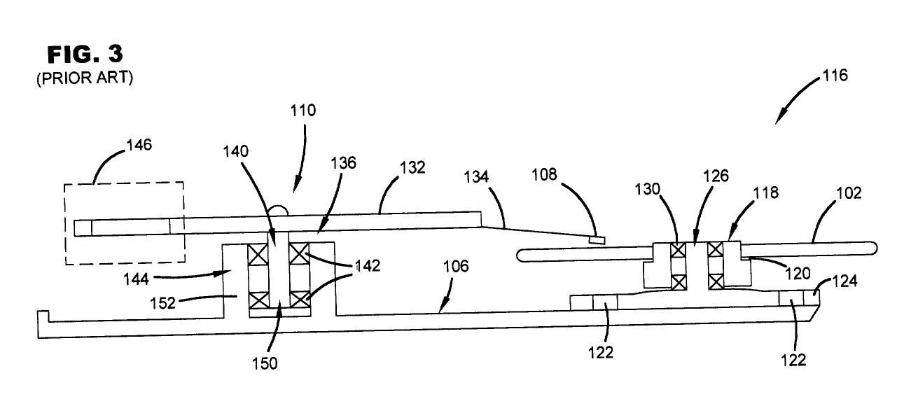

In particular, as shown in FIG. 3, the rotating disc spindle 118 is rotationally coupled to a spindle hub 126 by bearings 130 to rotationally support discs 102 for read-write operation. Heads read or write data to the rotating discs 102 via operation of the actuator assembly 110. In the embodiment illustrated in FIG. 3, the actuator assembly 110 includes a single actuator arm 132 having head 108 coupled thereto via a suspension assembly 134.

The actuator arm 132 is rotationally coupled to base chassis 106 of the device through an actuator spindle assembly 136 including a rotating actuator spindle 140. The actuator spindle 140 is rotationally supported by bearings 142 relative to a stationary actuator hub 144. In the embodiment shown, the actuator assembly 110 includes a motor assembly 146 coupled to the actuator arm 132 which is energized to rotate the actuator arm 132 for head placement as schematically illustrated. Alternatively the assembly includes multiple actuator arms coupled to the actuator spindle 140 to read or write data to a plurality of discs or opposed sides of a disc.

In the illustrated embodiment, the actuator spindle 140 includes a spindle shaft 150. The spindle shaft 150 is rotationally supported in a stationary sleeve 152 forming the spindle hub 144. As shown, the spindle sleeve 152 is formed on the base chassis 106. The actuator spindle components (e.g. spindle shaft 150) may be assembled in the spindle sleeve 152 at a different site or remote facility and thus the base chassis 106 must be transferred or shipped to the remote facility to assemble the actuator spindle assembly to the base chassis. Following assembly of the spindle components, the base chassis 106 is transferred or shipped to assembly other drive components. Transfer of the base chassis 106 can be expensive or difficult due to the weight and size of the base chassis 106.

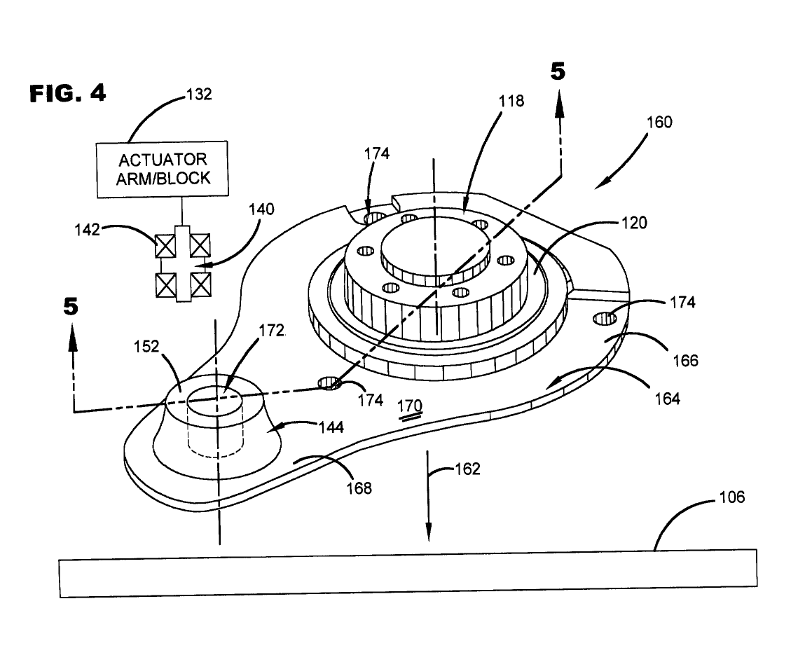

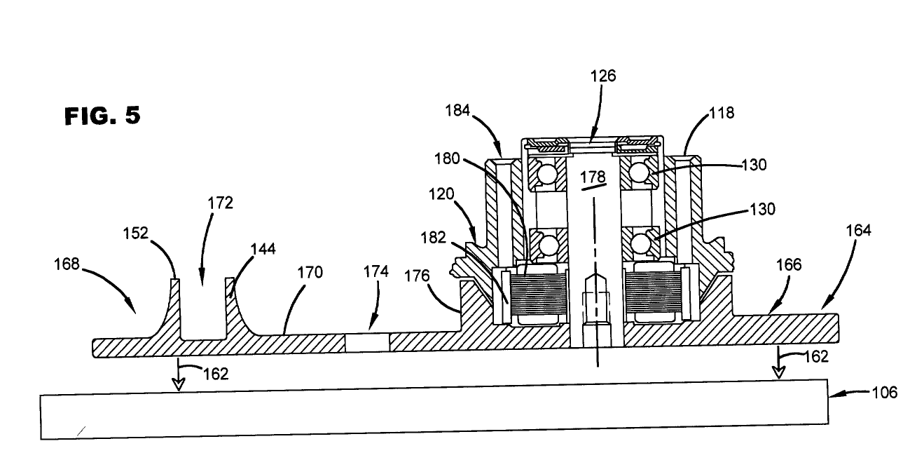

FIGS. 4-5 illustrate an embodiment of a composite base assembly 160 for a disc spindle motor and an actuator spindle assembly which is assembled to a base chassis 106 as illustrated by arrows 162. In the embodiment shown, the composite base assembly 160 includes a composite base 164 having a disc spindle portion 166, an actuator portion 168 and a flange portion 170. In the embodiment shown, the actuator portion 168 includes the actuator hub portion 144. In the embodiment shown, the actuator hub portion 144 includes stationary sleeve 152 formed on the composite base 164, although application is not limited to the particular actuator hub portion or structure shown. As shown, the rotating actuator spindle 140 includes rotating spindle shaft 150 which is rotationally assembled in a sleeve channel 172 of the sleeve 152 via bearings 142. The rotating disc spindle 118 of the disc spindle assembly is assembled on the disc spindle portion 166 of the composite base 164. In the illustrated embodiment, the flange portion 170 of the composite base 164 includes fastener openings 174 to secure the composite base 164 to the base chassis 106.

In particular as illustrated in the embodiment of FIG. 5, where like numbers are used to refer to like parts in the previous FIGS, the disc hub portion 126 includes hub shoulder 176 having a stationary shaft 178 coupled to and extending therefrom. In the particular embodiment shown, the stationary shaft is supported in an opening of the hub shoulder 176. As shown, an energizable coil 180 is assembled relative to the stationary shaft or disc hub portion 126. The rotating disc spindle 118 includes a magnet assembly 182 to interface with the energizable coil 180 on the disc hub portion 126 or stationary shaft 178 to form the motor component of the disc spindle motor assembly. The rotating disc spindle 118 is rotationally assembled relative to the stationary shaft 178 via bearings 130. Discs 102 are assembled on the rotating disc spindle 118 and clamped thereto via fastener holes 184 for operation. Alternate hub structures for the disc spindle motor and the actuator spindle assembly can be formed on the composite base 164. For example, the actuator hub portion of the composite base 164 may support a threaded shaft having an actuator spindle rotatable thereabout and application is not limited to the particular hub structures shown, nor is application limited to a particular spindle or rotational interface for the spindle motor or actuator spindle assembly.

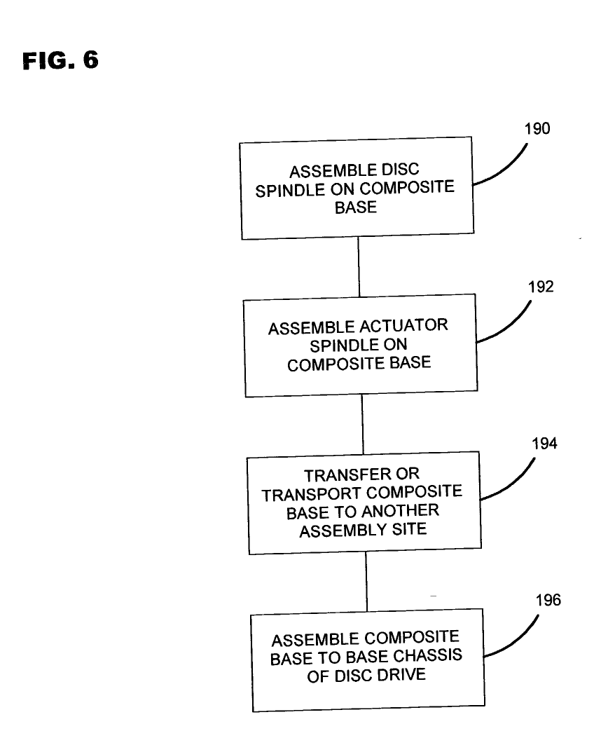

FIG. 6 is a flow chart of an assembly embodiment for the composite assembly of the present invention. The disc spindle 118 or assembly is assembled on the composite base as illustrated by block 190. The actuator spindle or components are assembled to the composite base as illustrated by block 192. In particular, the actuator spindle or components are assembled to the composite base at an actuator assembly site. The disc spindle is assembled on the composite base 164 at the same site or another site and the composite base is transferred as illustrated by block 194 to assemble the disc spindle motor, actuator spindle assembly or assemble the composite base to the base chassis of the disc drive as illustrated by block 196. Thereafter, discs are assembled on the disc spindle to form the disc spindle motor. The spindle assemblies for the spindle motor and actuator assembly are assembled on the composite base without transferring or shipping the base chassis 106 which provides advantages over prior direct fabrication or assembly to the base chassis 106.

A composite base (such as 164) for a disc spindle motor and an actuator spindle assembly including a spindle motor portion (such as 166), an actuator spindle portion (such as 168) and a flange portion (such as 170). The composite base includes a disc hub portion (such as 126) and an actuator hub portion (such as 144). The composite base is assembled to a base chassis (such as 106) of a disc drive to form the disc spindle motor assembly and the actuator spindle assembly of the data storage device.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application while maintaining substantially the same functionality without departing from the scope and spirit of the present invention. In addition, although the preferred embodiment described herein is directed to a particular data storage system, it will be appreciated by those skilled in the art that the teachings of the present invention can be applied to other data storage systems without departing from the scope and spirit of the present invention.

What is claimed is:

1. A composite assembly component for assembly to a base chassis of a data storage device comprising:
a composite base including a disc spindle portion, an actuator spindle portion and a flange portion;
a disc hub portion formed on the disc spindle portion of the composite base; and
an actuator hub portion formed on the actuator spindle portion of the composite base.

2. The composite assembly component of claim 1 wherein the flange portion of the composite base includes a plurality of fastener openings to assembly to the base chassis of the data storage device.

3. The composite assembly component of claim 1 wherein the disc hub portion includes a stationary spindle shaft.

4. The composite assembly component of claim 3 wherein the disc hub portion includes a shoulder portion having an opening and the stationary spindle shaft is disposed therein.

5. The composite assembly component of claim 1 wherein the actuator hub portion includes a stationary sleeve having a sleeve channel therein.

6. The composite assembly component of claim 1 wherein the disc hub portion includes a stationary shaft and further comprising:
a rotating disc spindle portion including a rim to support at least one disc; and
a bearing assembly rotationally coupling the rotating disc spindle portion to the stationary shaft.

7. The composite assembly component of claim 6 wherein the actuator hub portion includes a stationary sleeve having a sleeve channel and comprising:
a rotating actuator spindle including a spindle shaft disposed in the sleeve channel; and
a bearing assembly rotationally coupling the rotating actuator spindle relative to the stationary sleeve of the actuator hub portion.

8. The composite assembly component of claim 6 wherein the disc hub portion includes an energizable coil and the rotating disc spindle portion includes a magnet.

9. The composite assembly component of claim 6 wherein the rotating disc spindle portion includes at least one disc supported thereby.

10. The composite assembly component of claim 7 wherein the rotating actuator spindle includes at least one actuator arm coupled thereto.

11. A data storage device comprising:
a spindle motor assembly to rotationally support at least one disc;
an actuator spindle assembly to movably support at least one head to read data from or write data to the at least one disc; and
means for assembling the spindle motor assembly and the actuator spindle assembly to a base chassis of the data storage device.

12. The data storage device of claim 11 wherein the means for assembling the spindle motor assembly and the actuator spindle assembly to the base chassis includes fastener openings on a flange portion of a composite base for the spindle motor assembly and the actuator spindle assembly.

13. A method for assembling components of a data storage device comprising the steps of:
providing a composite base having a disc hub portion and an actuator hub portion;
assembling a rotating actuator spindle to the actuator hub portion at an actuator assembly site;
transferring the composite base to another site; and
assembling the composite base to a base chassis of the data storage device.

14. The method of claim 13 and further comprising the step of:
assembling a rotating disc spindle to the disc hub portion.

15. The method of claim 14 and further comprising the step of:
assembling discs on the disc spindle portion after assembling the composite base on the base chassis of the data storage device.

16. The method of claim 13 and further comprising the step of:
assembling an actuator having at least one actuator arm having a head coupled thereto to the rotating actuator spindle.

17. The method of claim 13 wherein the step assembling the composite base to the base chassis comprises the step of:
fastening the composite base to the base chassis via fastener openings.

18. The method of claim 14 wherein the disc hub portion includes a stationary spindle shaft and the step of assembling the disc spindle to the disc hub portion comprises steps of:
assembling an energizable coil relative to the disc hub portion and a magnet relative to the disc spindle; and
assembling the disc spindle and a bearing assembly about the stationary spindle shaft to rotationally couple the disc spindle to the disc hub portion.

19. The method of claim 13 wherein the actuator hub portion includes a stationary sleeve having a sleeve channel and the actuator spindle includes an actuator spindle shaft and the step of assembling the actuator spindle to the actuator hub portion comprises:
assembling the actuator spindle shaft and a bearing assembly in the stationary sleeve to rotationally couple the actuator spindle shaft to the actuator hub portion.
